(19) United States
(12) Patent Application Publication
(10) Pub. No.: US 2009/0127341 A1
(43) Pub. Date: May 21, 2009

(54) Bar-code reading tool

(76) Inventor: Xiangyang Feng, Singapore (SG)

Correspondence Address: HITACHI C/O WAGNER BLECHER LLP, 123 WESTRIDGE DRIVE, WATSONVILLE, CA, 95076, US

(21) Appl. No.: 11/986,284

(22) Filed: Nov. 19, 2007

(51) Int. Cl. G06K 7/10

(52) U.S. Cl. 235/462.08; 235/462.32; 235/462.15

(57) ABSTRACT

A bar-code-reading tool. A first mirror is disposed to receive light emitted by a bar-code reader. A second mirror is disposed to receive light reflected from a bar-code label affixed to an object. The first mirror and the second mirror are arranged in a folded optical path that is disposed for the bar-code reader to read the bar-code label. A fixture holds the object comprising the bar-code label on a planar base of the fixture and disposes the bar-code label in the folded optical path. The fixture is arranged so that the object is disposed above the planar base, and the bar-code reader is disposed below the planar base.

### TECHNICAL FIELD

Embodiments of the present invention relate generally to the field of bar-code readers.

### BACKGROUND

Direct access storage devices (DASDs), and in particular hard-disk drives (HDDs), are assembled in manufacturing facilities that require careful tracking of the individual hard-disk drives manufactured therein. At various stages in the assembly process, it is desirable to inventory an HDD, perform tests on an HDD, or simply track an HDD as it progresses through the manufacturing process. It is also desirable to follow an individual HDD throughout the manufacturing process, and, indeed, throughout its lifetime by its serial number. To facilitate such tracking of HDDs, serial numbers, as well as other information, are encoded in bar codes that are imprinted on bar-code labels that are affixed to the HDD.

Often these bar-code labels are read manually with a hand-held, bar-code reader. The manual reading of such bar-codes can be time-consuming, as well as fatiguing for the operator performing such tasks. Therefore, it is desirable to relieve the tedium and repetitive motion fatigue such operators experience in using hand-held, bar-code readers.

### SUMMARY

Various embodiments of the present invention are described herein. In an embodiment of the present invention, a first mirror is disposed to receive light emitted by a bar-code reader. A second mirror is disposed to receive light reflected from a bar-code label affixed to an object. The first mirror and the second mirror are arranged in a folded optical path that is disposed for the bar-code reader to read the bar-code label. A fixture holds the object comprising the bar-code label on a planar base of the fixture and disposes the bar-code label in the folded optical path. The fixture is arranged so that the object is disposed above the planar base, and the bar-code reader is disposed below the planar base.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a simplified schematic view of an enclosure of a hard-disk drive (HDD) as viewed from above showing the location of a bar-code label affixed to an HDD enclosure, in accordance with an embodiment of the present invention.

FIG. 2 is a simplified schematic view of the back side of an HDD enclosure as viewed from behind showing the location of a bar-code label affixed to an HDD enclosure, in accordance with an embodiment of the present invention.

FIG. 3 is a schematic view of the right side of an HDD enclosure as viewed perpendicularly to a plane defined by mirror normal axes that shows the arrangement of a folded optical path for reading a bar-code label affixed to an HDD enclosure, in accordance with an embodiment of the present invention.

FIG. 4 is a schematic view of the top side of an HDD enclosure as viewed from above showing the disposition of the HDD enclosure in a fixture for reading a bar-code label affixed to an HDD enclosure, in accordance with an embodiment of the present invention.

FIG. 5 is a schematic view of an unfolded optical path for reading a bar-code label on an HDD enclosure as viewed along the mirror normal axes showing the disposition of the bar-code label relative to the bar-code reader, in accordance with an embodiment of the present invention.

FIG. 6 is a flow chart illustrating an embodiment of the present invention for using a bar-code reading tool in reading a bar-code label affixed to an object.

FIG. 7 is a flow chart illustrating an embodiment of the present invention for further clamping an object in a fixture, and using the bar-code reading tool in reading a bar-code label affixed to an object.

FIGS. 8A-8B are a flow chart illustrating an embodiment of the present invention for further communicating with a computer, clamping an object in a fixture, and using the bar-code reading tool in reading a bar-code label affixed to an object.

FIGS. 9A-9B are a flow chart illustrating an embodiment of the present invention for further utilizing a computer for sending a command for clamping and unclamping an object in a fixture and using the bar-code reading tool in reading a bar-code label affixed to an object.

FIGS. 10A-10B are a flow chart illustrating an embodiment of the present invention for further utilizing a computer for both performing tests on an object and sending a command for clamping and unclamping an object in a fixture, and using the bar-code reading tool in reading a bar-code label affixed to an object.

The drawings referred to in this description should not be understood as being drawn to scale except if specifically noted.

### DESCRIPTION OF EMBODIMENTS

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of embodiments of the present invention, numerous specific details are set forth in order to provide a thorough understanding of the present invention. However, it should be recognized by one of ordinary skill in the art that embodiments of the present invention may be practiced without these specific details. In other instances, well known methods, procedures, and components have not been described in detail as not to unnecessarily obscure aspects of the present invention.

### Physical Description of Embodiments of the Present Invention for a Bar-Code Reading Tool

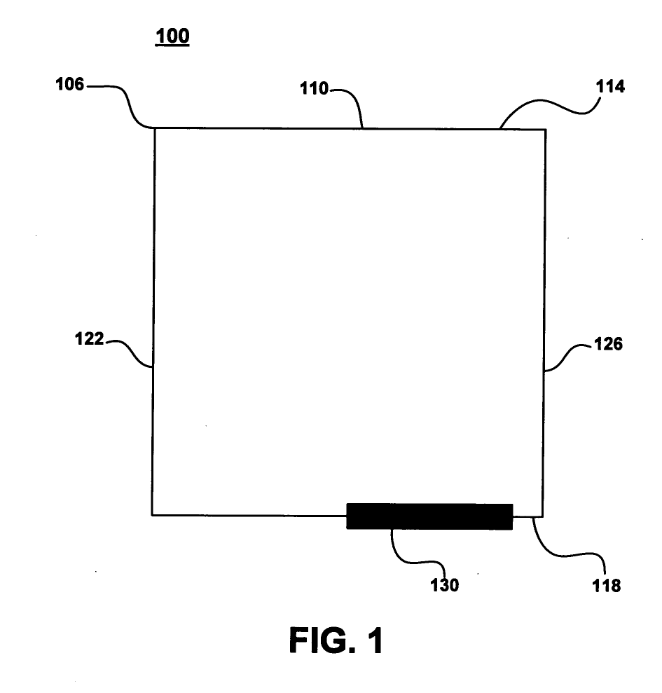

With reference to FIG. 1, a simplified schematic view of the enclosure of a hard-disk drive (HDD) as viewed from above shows the location of a bar-code label 130 that is read by a bar-code reading tool, in accordance with an embodiment of the present invention 100. As the name implies the HDD enclosure 106 encloses the operating component parts of an HDD, which includes a magnetic recording disk, a magnetic recording head that can be disposed in proximity to the disk for the recording of data thereto. In addition, the HDD includes a head suspension whereby the head is flown on an air-bearing over the surface of the disk; the air bearing is created by an air-bearing surface (ABS) that is fabricated on a slider in which the head is integrally fabricated. The HDD is further provided with a disk controller and recording channel electronics that control the accessing of tracks on the magnetic recording disk whereat data is recorded. To provide for the communication of data to and from the recording disk, electrical leads connect the recording elements of the recording head consisting of a write element and a read element to respective write and read electronic circuits of the recording channel. Moreover, the suspension is attached to an actuator arm that serves as the armature of a voice coil motor; the actuator assembly moves the head to various tracks on the disk in response to the head-disk controller's commands. It should be recognized that the features described above are only some of the essential component parts of an HDD, all of which have not been recited so as to not obscure the description of embodiments of the present invention.

In addition, the HDD enclosure 106 itself includes a housing, which may be a casting, and a printed circuit board (PCB) mounted on the bottom side of the HDD enclosure 106 and populated with HDD electronics for inputting data to and outputting data from the HDD, and a cover with air-flow channels that is mounted on the housing enclosing the cavity in which the head and disk are disposed. So as not to obscure the essence of embodiments of the present invention, these details of the HDD enclosure 106, as well as the HDD components described above, are not shown in FIG. 1. Rather, the HDD enclosure 106 is shown as a substantially rectangular-box-shaped object with a top side 110, a front side 114, a back side 118, a left side 122, and a right side 126; the HDD enclosure 106, also, has a bottom side 210 (not shown in FIG. 1). As used herein, a substantially rectangular-box-shaped object has six sides wherein one side meets another side at an edge and the edges meet at eight corners where each edge is about perpendicular to an edge it meets, as in a rectangular parallepiped having six rectangular sides; but, the sides may deviate from perfect planarity as do the sides of a typical box-like shipping container or other box-like enclosure, e.g. the HDD enclosure described above. As shown in profile, the bar-code label 130 is located on the back side 118 of the HDD enclosure 106; and in this case, towards the right side 126 of the HDD enclosure 106. But, the embodiments of the present invention encompass more generally other locations of the bar-code label 130 on the HDD enclosure 106, and the particular location shown should not be seen as limiting the scope of the invention.

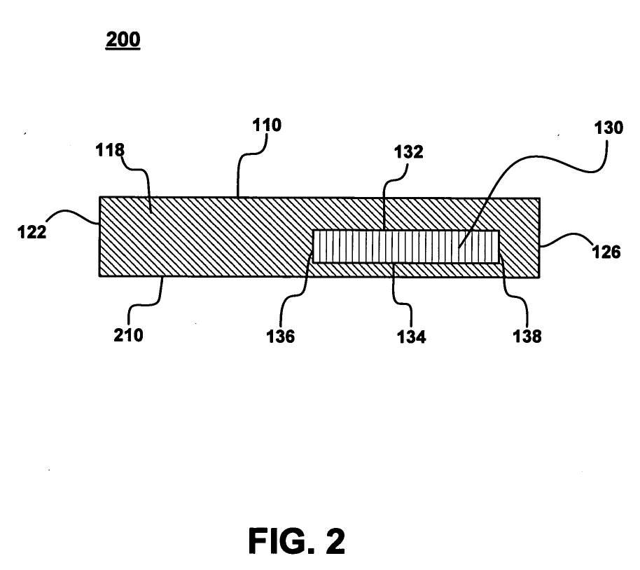

Now turning to FIG. 2, in accordance with an embodiment of the present invention 200, a simplified schematic view of the back side 118 of an enclosure 106 of a HDD as viewed from behind shows the location of a bar-code label 130 on back side 118 of the HDD enclosure 106, or other generic object, e.g. a rectangular-box-shaped object. As shown in this view, the following parts of the HDD enclosure 106 are seen: the top side 110, the back side 118, the left side 122, and the right side 126; also shown is the bottom side 210 of the HDD enclosure 106. It should be recognized that the left side 122 and the right side 126, and the top side 110 and the bottom side 210 appear in projection as vertical and horizontal line segments, respectively, because, in the view as shown, the direction of the projection lies parallel to these sides. On the other hand, the back side 118 appears as a generally oblong rectangle. On the back side 118 and located towards the right side 126 of the HDD enclosure 106, the bar-code label 130 is disposed. The bar-code label 130 is generally a rectangular piece of paper, or other material suitable for imprinting with a bar-code, affixed to the back side 118 of the HDD enclosure 106 having top and bottom edges 132 and 134 and left and right edges 136 and 138; the edges 132, 134, 136 and 138 are oriented about parallel to respective edges of the back side 118 of the HDD enclosure 106, but a bar-code label 130 can still be read even if tilted somewhat relative to the plane of a scan beam from a bar-code reader 310. The bar-code label 130 is imprinted with striations that, as shown, run vertically from the top to the bottom of the label about parallel to the left and right side of the bar-code label 130. As shown in FIG. 2, the striations have uniform spacing and width; but, it should be recognized that the spacing and width of the striations is more generally non-uniform, the width and spacing conveying information, for example, the serial number of an HDD to which it is affixed; and, the particular spacing and width shown should not be seen as limiting the scope of the invention.

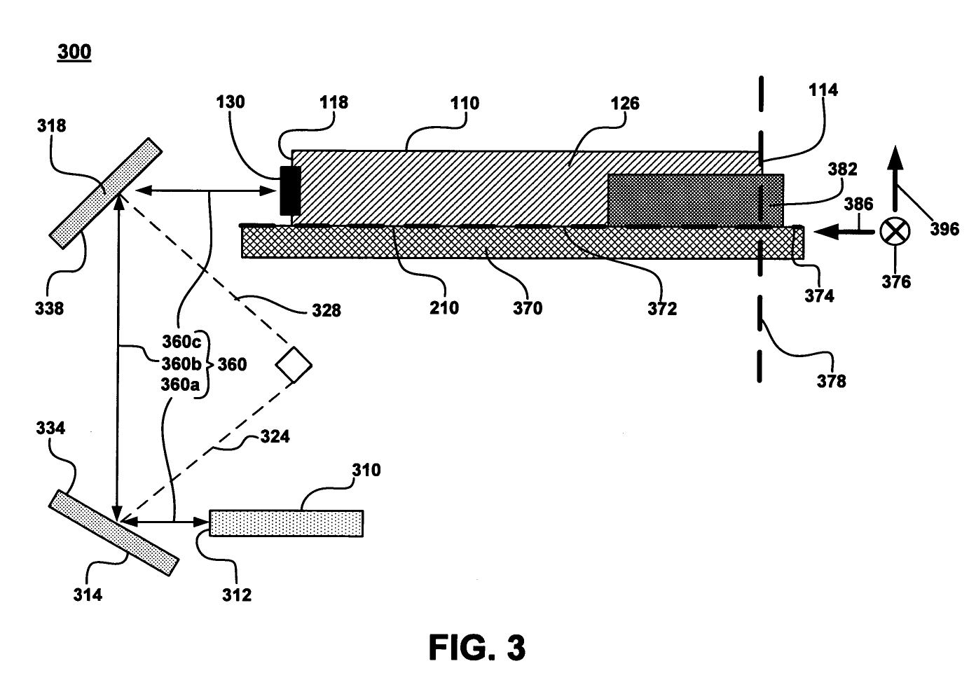

With reference now to FIG. 3, in accordance with an embodiment of the present invention 300, a schematic view of the right side 126 of an HDD enclosure 106 as viewed perpendicularly to a plane defined by mirror normal axes 324 and 328 shows the arrangement of the folded optical path 360 for reading a bar-code label 130 affixed to an HDD enclosure 106. As shown in this figure, the elements of the optical system for reading the bar-code label 130 are seen: a bar-code reader 310, a first mirror 314, a second mirror 318, and a bar-code label 130. The bar-code reader 310 has a light source for emitting light to illuminate the bar-code label 130, and a light detector for receiving light reflected back from the bar-code label 130. The light detector of the bar-code reader 310 may be either a charge-coupled-device (CCD) camera or a photodiode. The light source of the bar-code reader 310 may be either a light-emitting diode (LED) or a laser, as typically used with a CCD camera or a photodiode, respectively.

With further reference to FIG. 3, the first mirror 314, which serves as a first means for reflecting light, is disposed to receive light emitted by the bar-code reader 310, and has a first normal axis 324, which in the case of a planar mirror is about normal to the planar reflecting surface 334 of the first mirror 314. The second mirror 318, which serves as a second means for reflecting light, is disposed to receive light reflected from the bar-code label 130 affixed to the HDD enclosure 106, or other generic object, and has a second normal axis 328, which in the case of a planar mirror is similarly about normal to the planar reflecting surface 338 of the second mirror 318. The first and second normal axes 324 and 328 of the respective mirrors 314 and 318 are co-planar and about perpendicular to each other, and lie in a first plane, e.g. the plane of FIG. 3, as shown.

With further reference to FIG. 3, embodiments of the present invention are also suitable for reading bar-code labels affixed to a generic object, such as a rectangular-box-shaped object, like an HDD enclosure 106, or HDD enclosure 106 containing an HDD, e.g. an HDD. Thus, embodiments of the present invention are not limited only to the reading of bar-code labels on HDD's.

The bar-code reader 310 and the bar-code label 130 are disposed in a folded optical path 360 so that the bar-code reader 310 can read the bar-code label 130. As shown, the bar-code reader 310 and the bar-code label 130 are disposed at opposite ends of the folded optical path 360. The folded optical path 360 comprises three portions: a first optical-path portion 360a being disposed between the first mirror 314 and the bar-code reader 310, a second portion optical-path portion 360b being disposed between the first mirror 314 and the second mirror 318, and a third optical-path portion 360c being disposed between the second mirror 318 and the bar-code label 130. The first, second, and third optical-path portions 360a, 360b, and 360c are disposed for reading of the bar-code label 130 by the bar-code reader 310 and a central ray of the folded optical path 360 lies in a plane about parallel to the first plane.

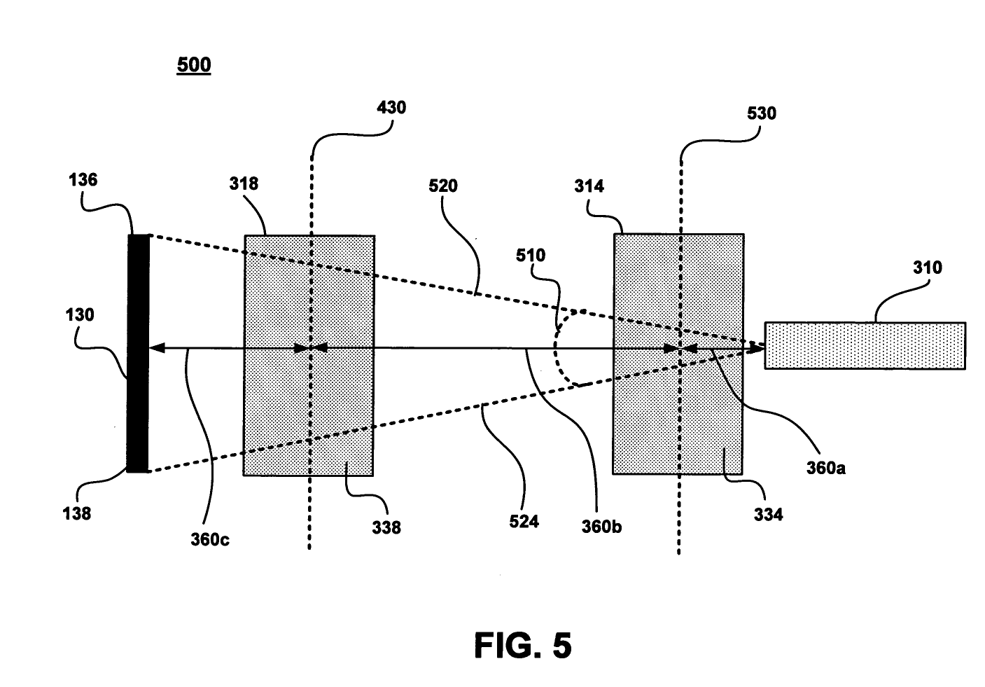

As shown, the optical path 360 is folded because light emitted by the light source of the bar-code reader 310 travels along the first optical-path portion 360a towards the first mirror 314, is reflected through a first angle by the first mirror 314, travels along the second optical-path portion 360b, is reflected through a second angle by the second mirror 318, and leaves the second mirror 318 traveling along the third optical-path portion 360c, which for the choice of central rays shown is directed along a direction opposite to the direction in which the light left the light source of the bar-code reader 310. As shown in FIG. 3, it should be recognized that the optical-path portions are shown as lying along central rays between the bar-code reader 310 and the bar-code label 130, but that for embodiments of the present invention the optical-path portions need not lie along such central rays, but only between respective elements along the folded optical path 360 of the optical system, e.g. the bar-code reader 310, the first and second mirrors 314 and 318, and the bar-code label 130, and that the particular rays shown are for illustrative purposes only. Thus, when viewed along the direction of the third optical-path portion 360b, the first and third optical-path portions 360a and 360c, lying along central rays, appear to be folded directly one on top of the other, but this is not the case in general, as will be seen with reference to FIG. 5.

Again with reference to FIG. 3, the folded optical path 360 may comprise rays that leave the bar-code reader 310 at various angles other than about normal to the face 312 of the bar-code reader 310 as shown, and may have sufficient divergence to reach portions at the top and bottom edges 132 and 134 and portions at the left and right edges 136 and 138 of the bar-code label 130. Likewise, the folded optical path 360 may comprise rays that leave the bar-code label 130 at various angles other than about normal to the back side 118 of the HDD enclosure 106 as shown, and have sufficient divergence to reach inside the aperture of the entrance pupil (not shown) of the light detector of the bar-code reader 310. It should be recognized that rays diverging from the central folded rays shown are within the scope contemplated for embodiments of the present invention.

With reference to FIG. 3, further discussing the propagation of light along the folded optical path 360 in an embodiment of the present invention 300, light traveling along the third optical-path portion 360c after leaving the second mirror 318 illuminates the bar-code label 130 on the back side 118 of an HDD enclosure 106, where the light is reflected by the bar-code label 130 and returns along the folded optical path 360 but traveling in the opposite direction until it reaches the light detector of the bar-code reader 310. In traversing the folded optical path 360, the light reflected from the bar-code label 130 travels along the third optical-path portion 360c towards the second mirror 318, is reflected through a third angle by the second mirror 318, travels along the second optical-path portion 360b towards the first mirror, is reflected through a fourth angle by the first mirror 314, and leaves the first mirror 314 traveling along the first optical-path portion 360a, which for the choice of central rays shown is directed along a direction opposite to the direction in which the light left the bar-code label 130, as well as opposite to the direction in which it initially left the light source of the bar-code reader 310. Again as described above, it should be recognized that the schematic ray diagram shown in FIG. 3 is for illustrative purposes only, and that the returning light from the bar-code label 130 may traverse the folded optical path 360 diverging somewhat from the idealized ray path shown to reach inside the aperture of the entrance pupil (not shown) of the light detector of the bar-code reader 310.

Light traveling along the first optical-path portion 360a after leaving the first mirror 314 illuminates the light detector of the bar-code reader 310, and is detected by a light detector. In response to the detected light coming from the bar-code label 130, the light detector may send a signal containing bar-code information about the bar-code label 130 from the bar-code reader 310 to a computer (not shown). Thus, the first mirror 314, and the second mirror 318 are arranged in a folded optical path 360 disposed for the bar-code reader 310 to read the bar-code label 130.

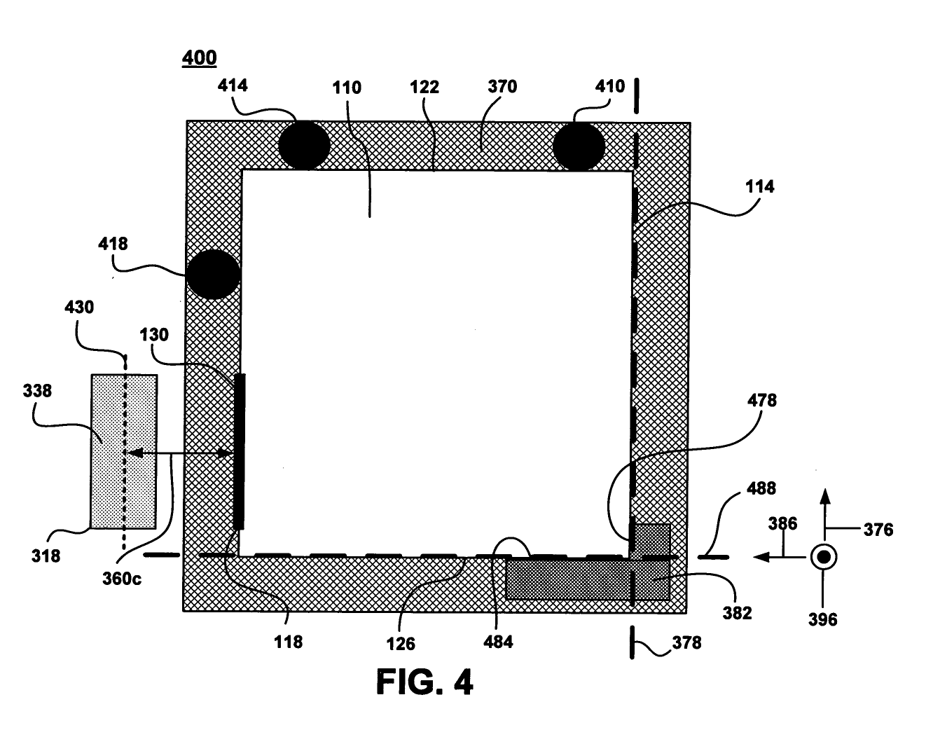

With further reference to FIG. 3, a fixture holds the HDD enclosure 106, or other generic object, on a planar base 370 that disposes the bar-code label 130 of the HDD enclosure 106, or other generic object, in and at the end of the folded optical path 360. The fixture, which is a holding means for fixing the HDD enclosure 106 on the planar base 370 and disposing the bar-code label 130 in the folded optical path 360, is arranged so that the HDD enclosure 106 is disposed above the planar base 370, and the bar-code reader 310 is disposed below planar base 370. A datum block 382 having a first datum surface 484 (shown in FIG. 4) for aligning the object in a first direction 376 lying in a second plane 374 of the top datum surface 372 of the planar base 370, and a second datum surface 478 (shown in FIG. 4) for aligning the HDD enclosure 106 in a second direction 386 about perpendicular to the first direction 376 and lying in the second plane 374 is used to register the HDD enclosure 106. Alignment is achieved by having the bar-code label 130 affixed to the back side 118 of the HDD enclosure 106 at a pre-determined location relative to the right side 126, the front side 114, and the bottom side 210 of the HDD enclosure 106. When the right side 126 and the front side 114 are registered in the datum block 382 with the datum surfaces 484 and 478 of the datum block 382, respectively, and when the bottom side 210 is registered with the top datum surface 372 of the planar base 370 of the fixture, the bar-code label 130 affixed to the HDD enclosure 106, or other generic object, is aligned with the second mirror 318 and within the folded optical path 360, and disposed for reading by the bar-code reader 310.

With further reference to FIG. 3, the top datum surface 372 of the planar base 370 lies in a second plane 374, and is situated to position the HDD enclosure 106 in a third direction 396 about normal to the second plane 374 to align the bar-code label 130 affixed to the HDD enclosure 106, or other generic object, with the second mirror 318 and within the folded optical path 360. Thus, the alignment of the bar-code label 130 for reading by the bar-code reader 310 is accomplished by bringing the respective sides 126, 114, and 210 of the HDD enclosure 106, or other generic object, into nominal coincidence with the respective planes 488, 378, 374 of the datum surfaces 484 and 478 of the datum block 382 and the top datum surface 372 of the planar base 370.

It should be recognized that as shown the three directions 376, 386, and 396 are about mutually orthogonal forming a so-called triad of perpendicular directions; the second direction 376 is perpendicular to the plane of FIG. 3 and directed into the plane of the figure as indicated by the arrow-tail symbol; and, the third direction 396 is perpendicular to the plane of FIG. 4 and directed out the plane of the figure as indicated by the arrow-head symbol. The traces of the planes 488, 378, and 374 are shown as dashed lines when lying about perpendicular to the planes of FIGS. 3 and 4; and when the traces of these planes are not shown in these figures, the planes lie about parallel to the planes of FIGS. 3 and 4.

Turning once more to FIG. 3, in another embodiment of the present invention, the mirrors 314 and 318 and the bar-code reader 310 may be attached to the fixture by means of a bracket (not shown). The bracket would generally dispose the folded optical path of the mirrors 314 and 318 and bar-code reader 310 so that the fixture aligns the HDD enclosure 106, or other generic object, and the bar-code label 130 for reading by the bar-code reader 310. The bracket would also dispose the bar-code reader 310 below the planar base 370 of the fixture. Thus, with a fixture further comprising a bracket for holding the mirrors 314 and 318 and the bar-code reader 310 as described above, or without such a bracket, the fixture is arranged so the HDD enclosure 106, or other generic object, is disposed above the planar base 370 of the fixture and the bar-code reader 310 is disposed below the planar base 370 of the fixture. This design of the optical system provides a compact arrangement of the optical elements of embodiments of the present invention.

With reference now to FIG. 4, in accordance with another embodiment of the present invention, a schematic view of the top side 110 of an HDD enclosure 106 as viewed from above shows the disposition of the HDD enclosure 106 in a fixture for reading the bar-code label 130. The fixture includes locator pins: a first locator pin 410 to locate left side 122 of the HDD enclosure 106, or other generic object, near its front side 114; a second locator pin 414 to locate left side 122 of the HDD enclosure 106 near its back side 118; and a third locator pin 418 to locate back side 118 of the HDD enclosure 106. The fixture also includes a datum block 382 having a first datum surface 484 for aligning the object in a first direction 376 lying in a second plane 374 of the top datum surface 372 of the planar base 370, and a second datum surface 478 for aligning the HDD enclosure 106 in a second direction 386 about perpendicular to the first direction 376 and lying in the second plane 374. The planar base 370 positions the HDD enclosure 106 in a third direction 396 normal to the second plane 374. The locator pins 410, 414, and 418, the datum block 382, and the planar base 370 align the bar-code label 130 affixed to the HDD enclosure 106, or other generic object, with the second mirror 318 and within the folded optical path 360 disposing the bar-code label 130 for reading by the bar-code reader 310 (not shown, because disposed below the planar base 370 as shown in FIG. 4).

With further reference to FIG. 4, the disposition of the bar-code label 130 on the HDD enclosure 106 is shown with respect to the second mirror 318. The mirror 318 is shown as though the substrate, upon which the planar reflecting surface 338 is supported, has been removed to elucidate the relationship of the third optical-path portion 360c to the second mirror 318, the bar-code label 130 of the HDD enclosure 106, or other generic object, and various component parts of the fixture: the locator pins 410, 414, and 418, the datum block 382, and the base 370. It should be recognized that the third optical-path portion 360c as shown lies along a central ray of the optical system, which is about normal to the center of the bar-code label 130 and about normal to the center line 430 of the reflecting surface 338 of the second mirror 318. It should also be recognized that the mirror 318 is titled about the axis defined by the center line 430 so as to reflect rays coming form the bar-code label 130 down to the first mirror 314 disposed below it and along the folded optical-path 360 back to the bar-code reader 310 (not shown) disposed below the planar base 370 of the fixture.

With further reference to FIG. 4, in accordance with other embodiments of the present invention, the planar base 370 of the fixture may be disposed to be about co-planar with another platform (not shown). This platform may be a manufacturing platform as on an assembly line, or the top of a work bench. In an embodiment of the present invention, the fixture may further comprise a clamping mechanism for clamping, or a clamp for restraining, the HDD enclosure 106, or other generic object, in the fixture. In another embodiment of the present invention, the fixture may include a first electrical connection block having terminals connected to external leads for supplying test signals to the HDD; the first electrical connection block may engage a second mating electrical connection block on the HDD. The test signals may be provided by a program run by a computer, or a programming means for performing a computer-controlled test on the HDD, or other generic object. In another embodiment of the invention, the computer may also communicate with the bar-code reader 310 for receiving a signal from the bar-code reader 310 in response to reading a bar-code label 130, the signal containing bar-code information. It should be recognized that these preceding features of the bar-code-reading tool facilitate automated reading of a bar-code label 130 for ease of use in a manufacturing process.

In another embodiment of the present invention that facilitates reading the bar-code label 130, the bar-code-reading tool includes a start switch to initiate reading the bar-code label 130 affixed to the HDD enclosure 106, or other generic object. In an embodiment of the present invention, the start switch may be a push button to facilitate manual activation by a human operator. However, it should be recognized that embodiments of the present invention also include both human and non-human operators, or robots, that would place and register an HDD enclosure 106, or other generic object, on the fixture positioned so as to have a bar-code label 130 affixed to the HDD enclosure 106 read, and that would activate the start switch. In another embodiment of the invention, after activation of the start switch in response to a start signal a clamping mechanism may clamp the HDD enclosure 106 in the fixture, the bar-code reader 310 may then read the bar-code of the HDD enclosure 106, and send a signal upon completion of reading the bar-code label 130 to the clamping mechanism to unclamp the HDD enclosure 106, or other generic object, from the fixture. Alternatively, in another embodiment of the invention, a start signal may be sent by the start switch to the computer; and, a signal containing bar-code information about the bar-code label 130 may be sent to the computer in communication with the bar-code reader 310 to receive the signal from the bar-code reader 310 in response to reading a bar-code label 130 at the same, or a later, time.

In accordance with an embodiment of the present invention, a start signal may be sent by the start switch to the computer. In response, the computer may send a clamping command to the clamping mechanism to clamp the object in the fixture; and, the bar-code reader 310 may send a signal containing bar-code information about the bar-code label 130 to the computer, after reading the bar-code label 130. Subsequently, the computer may send an unclamping command to the clamping mechanism to unclamp the HDD enclosure 106, or other generic object, in the fixture, thus preparing the fixture to receive another HDD enclosure 106 for reading of its bar-code label 130 after the previous HDD enclosure 106 has been removed from the fixture. Whether or not the computer may send a clamping or unclamping command, in embodiments of the present invention, the computer may perform computer-controlled tests on the HDD, or other generic object, by supplying test signals to the first electrical connection block attached to the fixture, after receiving the start signal from the start switch, and save the tests results in a file associated with, or identified by, the bar-code information of the bar-code label 130 sent by the bar-code reader 310. In embodiments of the present invention, one such test that may be performed on an HDD contained in an HDD enclosure 106 is a particle count test.

With reference now to FIG. 5, in accordance with another embodiment of the present invention, a schematic view shows the unfolded optical path for reading a bar-code label 130 on an HDD enclosure 106, or other generic object. The optical path appears as it would if the mirrors 314 and 318 were rotated about their respective mirror center lines 530 and 430 so that the mirror normal axes 324 and 328 are about normal to the plane of the figure. Thus, the respective reflecting surfaces 334 and 338 of the mirrors 314 and 318 are no longer disposed to reflect light as it propagates from the bar-code reader 310 to the bar-code label 130. The schematic view thus shows the disposition of the bar-code label 130 relative to the reading beam of the bar-code reader 310. It should be recognized that the angle subtended 510 by the bar-code label 130 should be less than the scan angle of the emitted light from the light source, a typical value for the latter being about 40 degrees.

As seen in FIG. 5, the unfolded optical path has the same three optical-path portions: the first optical-path portion 360a having a length, opl₁; the second optical-path portion 360b having a length, opl₂; the third optical-path portion 360c having a length, opl₃. The folded optical path 360 has a total optical-path length, opl, that is the sum of opl₁, opl₂, and opl₃, which can be more easily seen in FIG. 5. The total optical-path length, opl, is less than some maximum optical-path length, oplₘₐₓ, determined by the maximum range of a reading distance of the bar-code reader 310, known in the art as the optical throw; typical values of the optical throw, or maximum optical-path length, oplₘₐₓ, range from 16 cm up to 90 cm depending on, amongst other factors, the format of the bar code being read. Also, the total optical-path length, opl, is greater than some minimum optical path length, oplₘᵢₙ, determined by the minimum range of a reading distance of the bar-code reader 310; typical values of the minimum optical-path length, oplₘᵢₙ, range from 5.5 cm up to 10.8 cm depending on, amongst other factors, the format of the bar code being read.

It should be recognized that the sum of the optical-path lengths, opl₁, opl₂, and opl₃, or the total optical-path length, opl, for the extreme left ray 520 defined at the left edge 136 of the bar-code label 130, and the extreme right ray 524 defined at the right edge 138, is greater than the value of the total optical-path length, opl, for a central ray, and that the total optical-path length, opl, for optical paths along these extreme rays should also lie within the ranges specified above. Moreover, it should be recognized that, although the optical path of the extreme left ray 520 and the extreme right ray 524 deviate from a plane parallel to the first plane, the central ray for the folded optical path of the optical system lies in a plane about parallel to the first plane.

### Description of Embodiments of the Present Invention for a Method of Reading a Bar-Code Label Affixed to an HDD Enclosure, or Other Generic Object

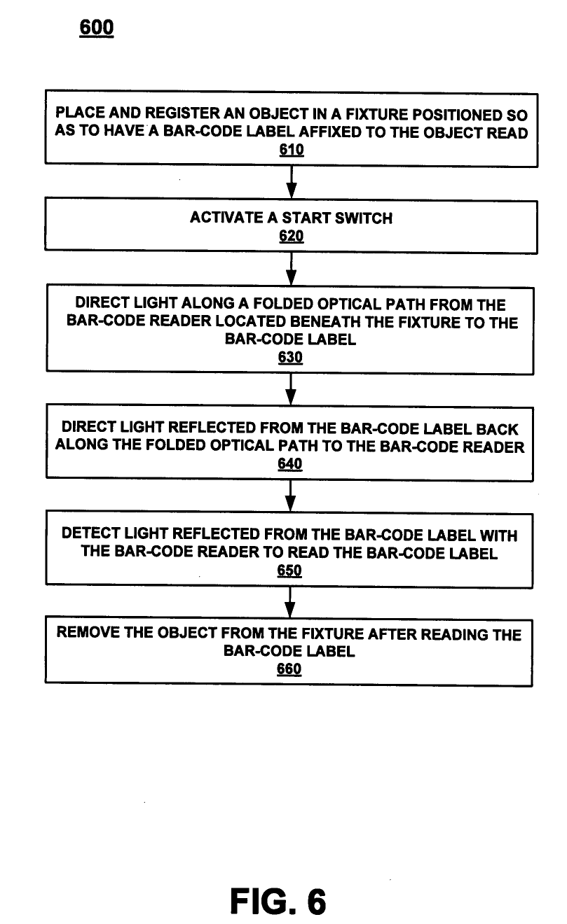

With reference now to FIG. 6, a flow chart illustrates an embodiment of the present invention 600 for a method of using a bar-code reading tool for reading a bar-code label 130 affixed to an HDD enclosure 106, or other generic object. First 610, an object is placed and registered in a fixture positioned so as to have a bar-code label 130 affixed to the object read. A start switch is activated 620. Next 630, light is directed along a folded optical path 360 from a bar-code reader 310 located beneath the fixture to the bar-code label 130. Next 640, the light reflected from the bar-code label 130 is directed back along the folded optical path 360 to the bar-code reader 310. 650, light reflected from the bar-code label 130 is detected with the bar-code reader 310 to read the bar-code label 130. Finally 660, after reading the bar-code label 130, the object is removed from the fixture.

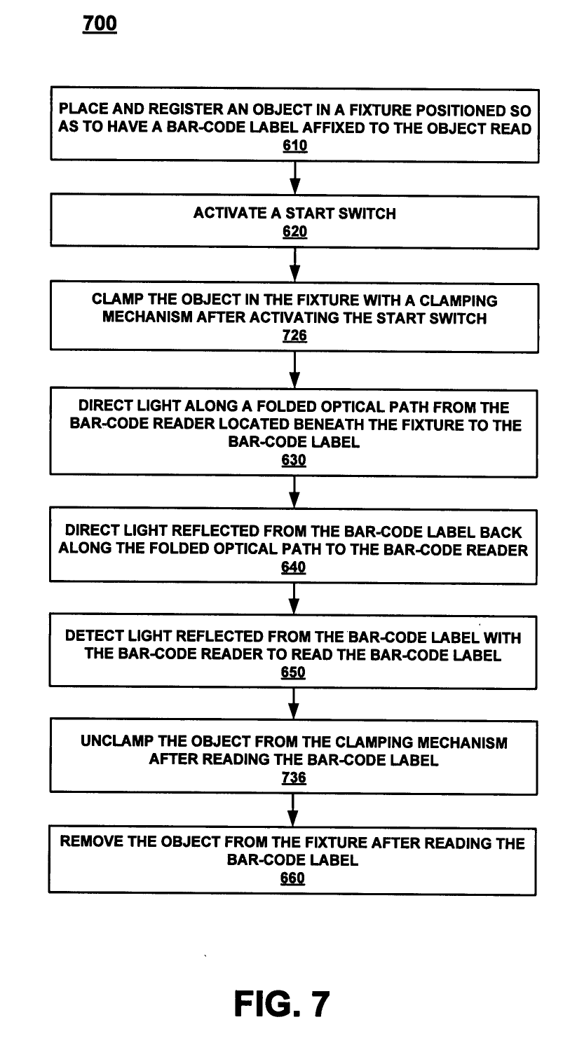

With reference now to FIG. 7, a flow chart illustrates another embodiment of the present invention 700 for a method of using a bar-code reading tool for reading a bar-code label 130 affixed to an HDD enclosure 106, or other generic object. The method is similar to that illustrated in FIG. 6, but further incorporates clamping an object in the fixture before reading the bar-code label 130 and unclamping the object after reading the bar-code label 130. After activating the start switch, the object is clamped 726 in the fixture with a clamping mechanism. After reading the bar-code label 130, the object is unclamped 736 from the clamping mechanism.

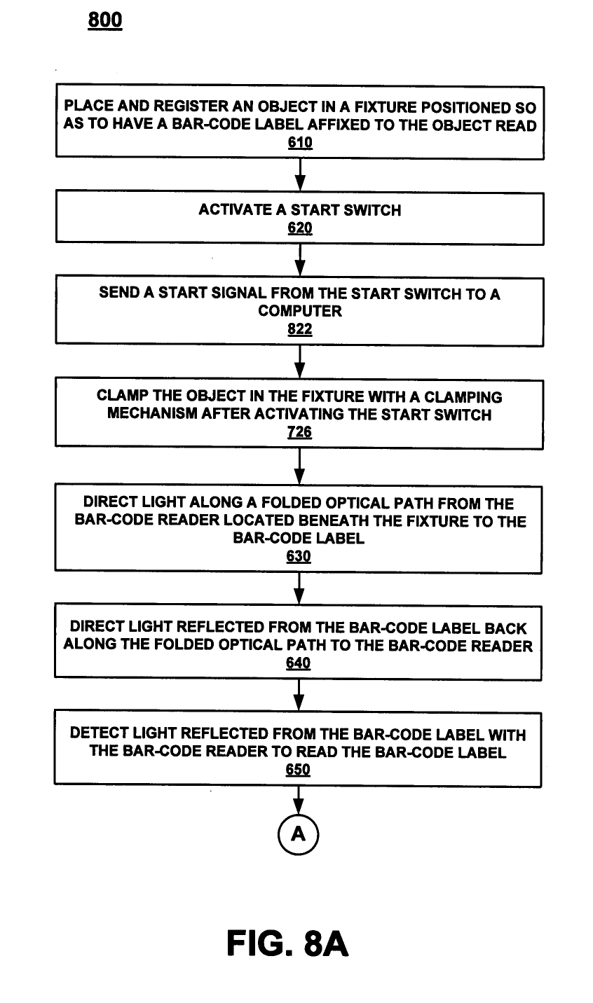

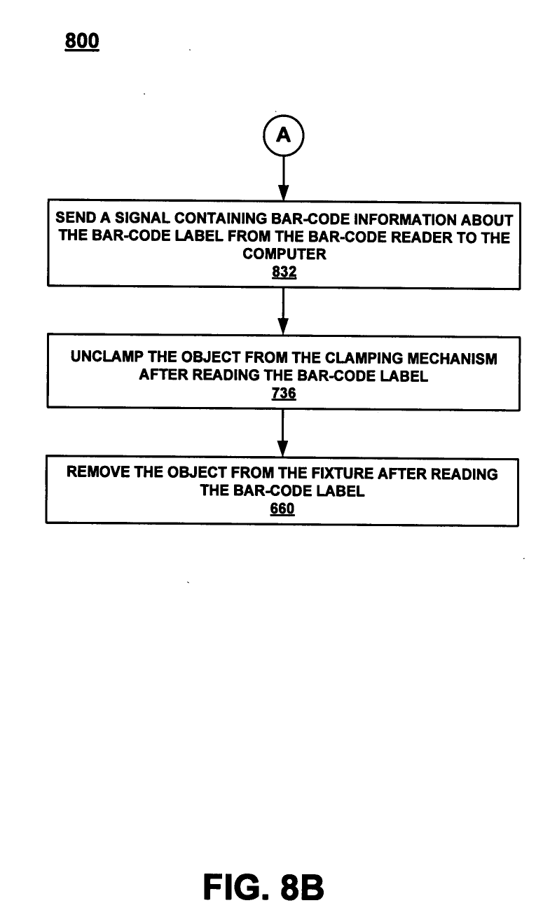

With reference now to FIGS. 8A-8B, a flow chart illustrates another embodiment of the present invention 800 for a method of using a bar-code reading tool for reading a bar-code label 130 affixed to an HDD enclosure 106, or other generic object. The method is similar to that illustrated in FIG. 7, but further incorporates communicating with a computer before reading the bar-code label 130, and sending bar-code information about the bar-code label 130 to a computer after reading the bar-code label 130. After activating the start switch, a start signal is sent 822 from the start switch to a computer. After reading the bar-code label 130, a signal containing bar-code information about the bar-code label 130 is sent 832 from the bar-code reader 310 to the computer.

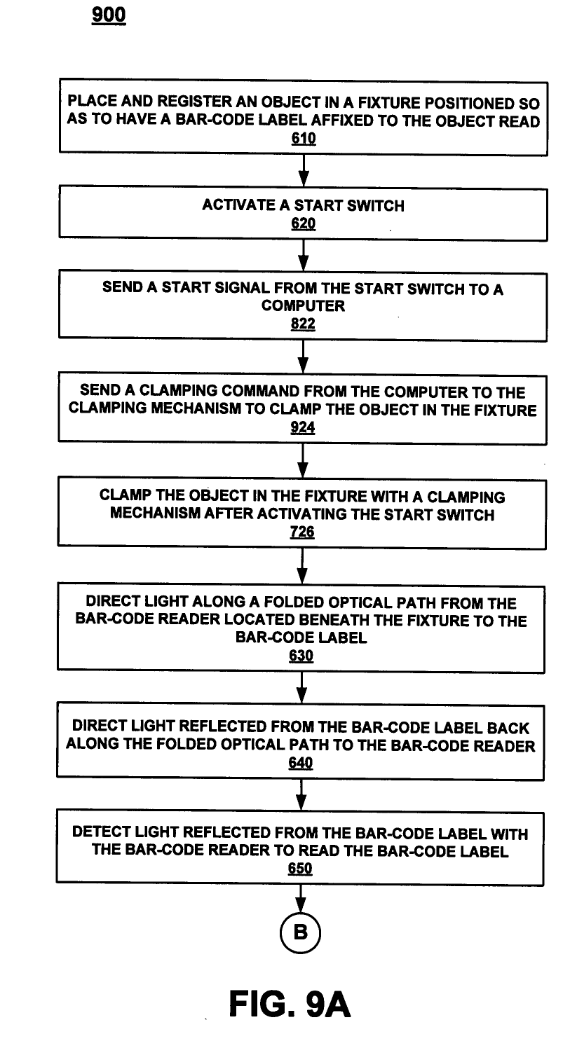

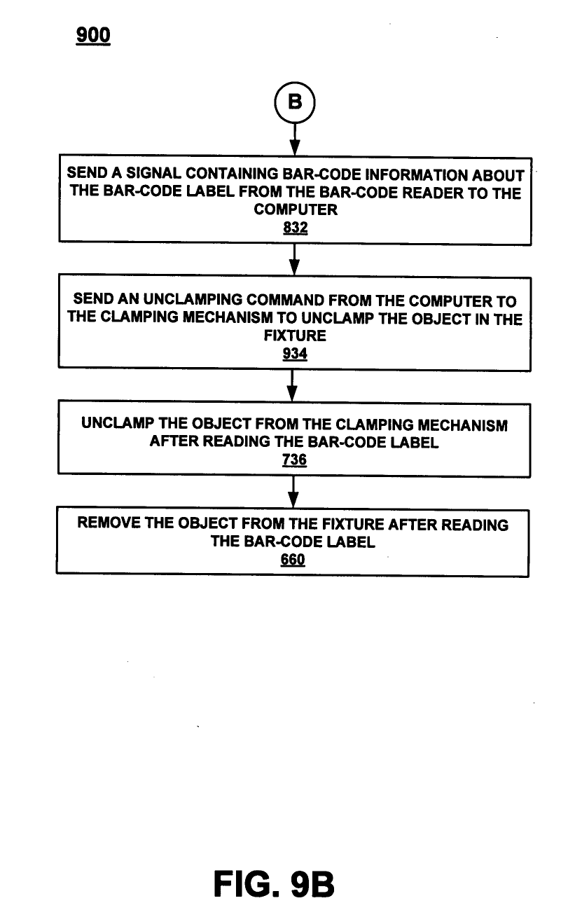

With reference now to FIGS. 9A-9B, a flow chart illustrates another embodiment of the present invention 900 for a method of using a bar-code reading tool for reading a bar-code label 130 affixed to an HDD enclosure 106, or other generic object. The method is similar to that illustrated in FIG. 8, but further incorporates sending a clamping command from the computer before reading the bar-code label 130, and sending an unclamping command from the computer after reading the bar-code label 130. After a start signal is sent 822 from the start switch to the computer, a clamping command is sent 924 from the computer to the clamping mechanism to clamp the object in the fixture. After a signal containing bar-code information about the bar-code label 130 is sent 832 from the bar-code reader 310 to the computer, an unclamping command is sent 934 from the computer to the clamping mechanism to unclamp the object in the fixture.

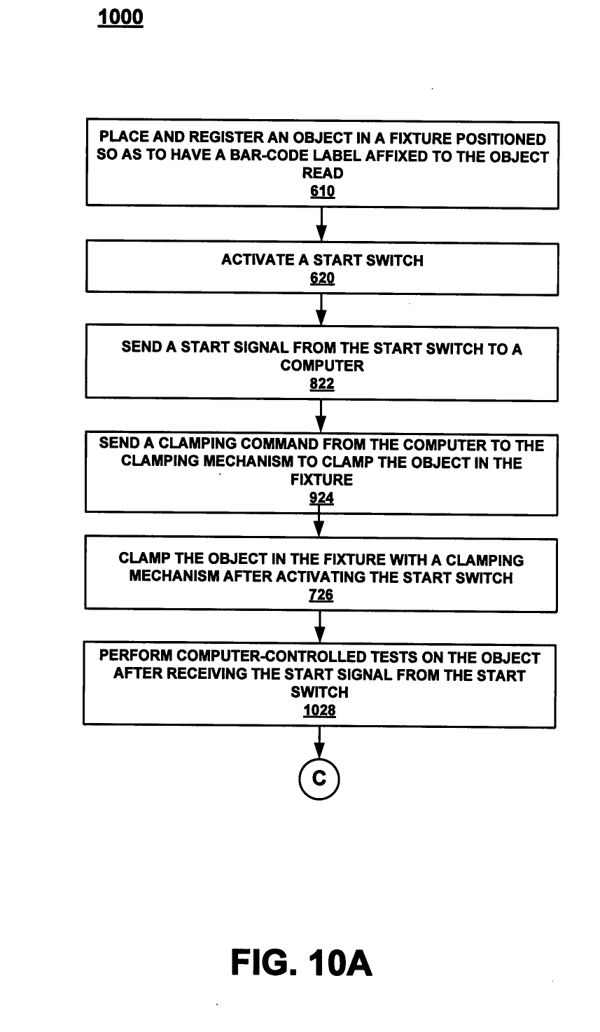

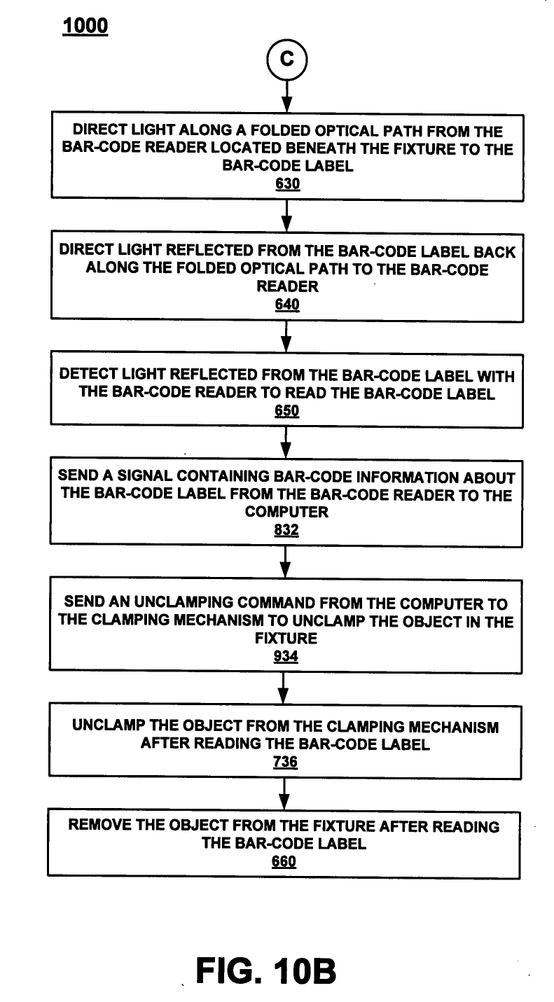

With reference now to FIGS. 10A-10B, a flow chart illustrates another embodiment of the present invention 1000 for a method of using a bar-code reading tool for reading a bar-code label 130 affixed to an HDD enclosure 106, or other generic object. The method is similar to that illustrated in FIGS. 9A-9B, but further incorporates performing computer-controlled tests on the object after receiving the start signal from the start switch. After a start signal is sent 822 from the start switch to the computer, computer-controlled tests are performed 1028 on the object; it should be recognized that the tests may be performed after a clamping command is sent 924 from the computer to the clamping mechanism to clamp the object in the fixture, and before an unclamping command is sent 934 from the computer to the clamping mechanism to unclamp the object in the fixture. However, in accordance with an embodiment of the present invention, the clamping and unclamping need not be commanded by the computer but may be provided by other means. It should also be recognized that, although the performing 1028 computer-controlled tests on the object occurs after receiving the start signal from the start switch, the performing 1028 computer-controlled tests on the object need not occur before reading the bar-code label 130, or before sending 832 a signal containing bar-code information about the bar-code label 130 from the bar-code reader 310 to the computer. In accordance with an embodiment of the present invention, it is contemplated that the performing 1028 computer-controlled tests on the object may occur after reading the bar-code label 130, or after sending 832 a signal containing bar-code information about the bar-code label 130 from the bar-code reader 310 to the computer.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A bar-code-reading tool comprising:
a first mirror disposed to receive light emitted by a bar-code reader;
a second mirror disposed to receive light reflected from a bar-code label affixed to an object, wherein said first mirror and said second mirror are arranged in a folded optical path disposed for said bar-code reader to read said bar-code label; and
a fixture for holding said object comprising said bar-code label on a planar base of said fixture and disposing said bar-code label in said folded optical path, wherein said fixture is arranged so that said object is disposed above said planar base and said bar-code reader is disposed below said planar base.

2. The bar-code-reading tool as in claim 1 wherein:
the first mirror has a first normal axis, the second mirror has a second normal axis, and said first and second normal axes are co-planar and about perpendicular to each other and lie in a first plane.

3. The bar-code-reading tool as in claim 2 wherein said folded optical path comprises:
a first optical-path portion being disposed between the first mirror and the bar-code reader;
a second portion optical-path portion being disposed between the first mirror and the second mirror; and
a third optical-path portion being disposed between the second mirror and the bar-code label;
wherein the first, second, and third optical-path portions are disposed for reading of the bar-code label by the bar-code reader and a central ray of the folded optical path lies in a plane about parallel to said first plane.

4. A bar-code-reading tool as in claim 3, wherein:
the first optical-path portion has length, opl₁;
the second optical-path portion has length, opl₂;
the third optical-path portion has length, opl₃; and
wherein the total optical-path length, opl, being the sum of opl₁, opl₂, and opl₃ is greater than some minimum optical-path length, oplₘᵢₙ, and less than some maximum optical-path length, oplₘₐₓ, determined by the range of a reading distance of said bar-code reader.

5. The bar-code-reading tool as in claim 1 wherein the fixture comprises:
locator pins to locate the object;
a datum block comprising a first datum surface for aligning the object in a first direction lying in a second plane of said planar base, and a second datum surface for aligning the object in a second direction about perpendicular to said first direction and lying in said second plane to register the object;
wherein said planar base positions the object in a third direction normal to said second plane; and
wherein said locator pins, said datum block, and said planar base align said bar-code label affixed to said object with the second mirror and within the folded optical path disposing the bar-code label for reading by the bar-code reader.

6. The bar-code-reading tool as in claim 1 wherein the planar base of the fixture is disposed to be about co-planar with a platform.

7. A bar-code-reading tool as in claim 1, further comprising a bar-code reader comprising a light source and a light detector, wherein said light source of the bar-code reader is selected from the group consisting of a light-emitting diode and a laser, and wherein said light detector of the bar-code reader is selected from the group consisting of a charge-coupled-device camera and a photodiode.

8. A bar-code-reading tool as in claim 1, further comprising a computer in communication with the bar-code reader for receiving a signal from the bar-code reader in response to reading a bar-code label.

9. A bar-code-reading tool as in claim 1, further comprising a clamp for restraining said object with the bar-code label in the fixture.

10. A bar-code-reading tool as in claim 1, further comprising a start switch to initiate reading the bar-code label affixed to said object.

11. A bar-code-reading tool as in claim 10, wherein the start switch is a push button to facilitate manual activation by a human operator.

12. A bar-code-reading tool as in claim 1, wherein the object comprising the bar-code label comprises a substantially rectangular-box shape.

13. A bar-code-reading tool as in claim 1, wherein the object is a hard-disk drive enclosure.

14. A bar-code-reading tool as in claim 13, further comprising a first electrical connection block comprising terminals connected to external leads for supplying test signals to said hard-disk drive, and to engage a second mating electrical connection block on said hard-disk drive.

15. A method of reading a bar-code label affixed to an object comprising:
placing and registering an object in a fixture positioned so as to have a bar-code label affixed to the object read;
activating a start switch;
directing light along a folded optical path from a bar-code reader located beneath said fixture to said bar-code label;
directing light reflected from said bar-code label back along said folded optical path to said bar-code reader;
detecting light reflected from said bar-code label with the bar-code reader to read said bar-code label; and
removing the object from the fixture after reading the bar-code label.

16. A method of reading a bar-code label affixed to an object as in claim 15 further comprising:
clamping the object in said fixture with a clamping mechanism after activating the start switch; and
unclamping the object from said clamping mechanism after reading the bar-code label.

17. A method of reading a bar-code label affixed to an object as in claim 16 further comprising:
sending a start signal from said start switch to a computer; and
sending a signal containing bar-code information about the bar-code label from said bar-code reader to said computer.

18. A method of reading a bar-code label affixed to an object as in claim 16 further comprising:
sending a start signal from said start switch to a computer;
sending a clamping command from said computer to the clamping mechanism to clamp the object in the fixture;
sending a signal containing bar-code information about the bar-code label from said bar-code reader to said computer; and
sending an unclamping command from said computer to the clamping mechanism to unclamp the object in the fixture.

19. A method of reading a bar-code label affixed to an object as in claim 17 further comprising:
performing computer-controlled tests on said object after receiving said start signal from said start switch.

20. A method of reading a bar-code label affixed to an object as in claim 18 further comprising:
performing computer-controlled tests on said object after receiving said start signal from said start switch.

21. A bar-code-reading tool comprising:
a first means for reflecting light disposed to receive light emitted by a bar-code reader;
a second means for reflecting light disposed to receive light reflected from a bar-code label affixed to an object;
wherein said first means for reflecting light, and said second means for reflecting light are arranged in a folded optical path disposed for said bar-code reader to read said bar-code label;
a holding means for fixing said object comprising said bar-code label on a planar base of said holding means and disposing said bar-code label in said folded optical path; and
wherein said holding means is arranged so that said object is disposed above said planar base and said bar-code reader is disposed below said planar base.

22. A bar-code-reading tool as in claim 21, further comprising a computer in communication with the bar-code reader for receiving a signal from the bar-code reader in response to reading a bar-code label.

23. A bar-code-reading tool as in 22 wherein the computer further comprises:
a programming means for performing a computer-controlled test on said object.

24. A bar-code-reading tool as in claim 21, wherein the object is a hard-disk drive.

25. A bar-code-reading tool as in claim 21, wherein the object comprising the bar-code label comprises a substantially rectangular-box shape.
